(19) United States
(12) Patent Application Publication
(10) Pub. No.: US 2005/0107042 A1
(43) Pub. Date: May 19, 2005

(54) Transmitter and/or receiver module

(76) Inventor: Antonius Johannes Matheus De Graauw, Nijmegen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/502,789

(22) PCT Filed: Jan. 17, 2003
(86) PCT No.: PCT/IB03/00125

(30) Foreign Application Priority Data
Jan. 31, 2002 (EP) 02075386.9

(51) Int. Cl. H04B 1/44; H04M 1/00

(52) U.S. Cl. 455/78; 455/550.1

(57) ABSTRACT

The transmitter and/or receiver module comprises a dipole antenna (28) and a matching circuit (26) matching the output impedance of the module to the antenna impedance, a switch circuit (24) for switching between received and transmitted signals, a power amplifier (30) for amplifying the transmitted signal, and a low-noise receiver amplifier (32) for amplifying the received signal, wherein the matching circuit (26) and the antenna (28) are designed to provide a bandpass filter function for the module. Differential signals are provided from the transmitter power amplifier (30) to the antenna (28) and/or from the antenna (28) to the receiver amplifier (32) without conversion of the differential signals to single-ended signals.

The invention relates to a method of processing signals in a transmitter and/or receiver module, a transmitter and/or receiver module, and an substrate with an antenna module to be used in the transmitter and/or receiver module. The invention further relates to a consumer electronics device.

The complexity of a typical transceiver front-end is often determined by the requirements for isolation of the receiver and transmitter, by requirements for out-of-band filtering and by the need for conversion between single-ended and differential signals. To fulfill these requirements, a balun, i.e. a balance-unbalance circuit, a switch, and a bandpass filter are required in conventional modules. In addition, an antenna plus matching network is required.

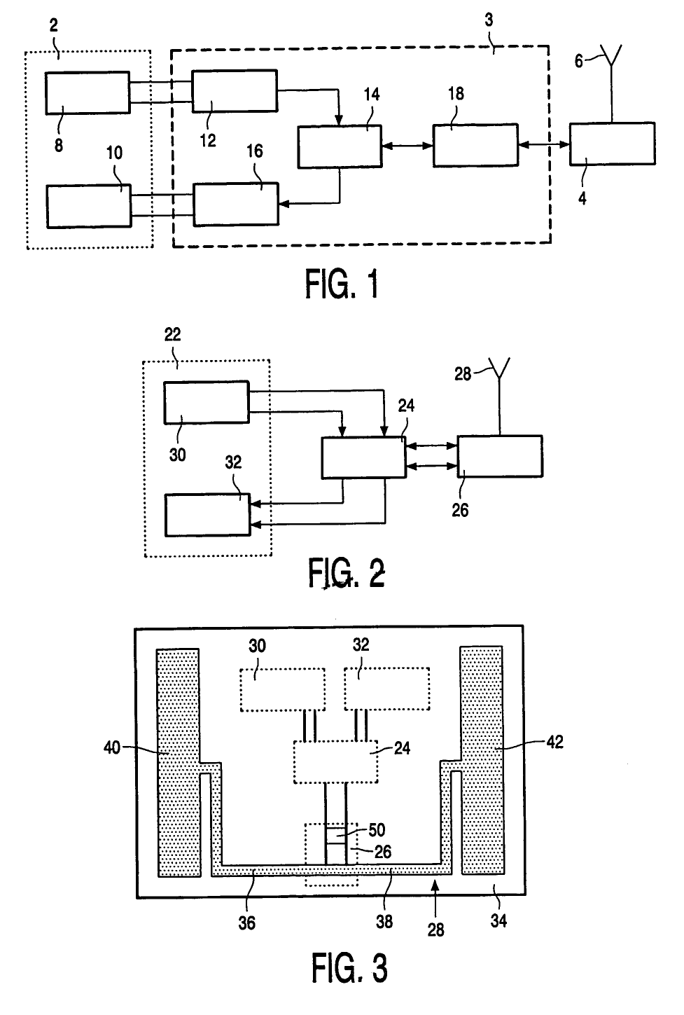

FIG. 1 shows the blockdiagram of a conventional front end transmitter/receiver circuit 2, a matching circuit 4, and an antenna 6 connected to the matching circuit 4, as well as a cascade circuit 3 connecting the transmitter/receiver circuit to the matching circuit 4. The transmitter/receiver circuit 2 comprises a power amplifier 8 (PA) for the transmitter function and a low-noise amplifier 10 (LNA) for the receiver function. The cascade circuit 3 comprises a balun circuit 12 (BAL) between the power amplifier 8 and a transmit/receive switch 14 (SW), another balun circuit 16 between the low-noise amplifier 10 and the switch 14, and a bandpass filter 18 (BPF) between the switch 14 and the matching circuit 4 of the antenna 6.

The power amplifier 8 is an electronic amplifier which is designed for delivering a significant amount of RF power to be transmitted by the antenna 6. The low noise amplifier 10 is an electronic amplifier which is designed for amplifying weak signals received by the antenna 6. The balun circuits 12, 16 transform a balanced signal to an unbalanced signal and vice versa. A balanced signal is a signal that consists of a voltage difference between two identical conductors. An unbalanced signal is a signal that consists of a voltage difference between a conductor and the signal ground. The transmit/receive switch 14 isolates the receiver amplifier 10 from the transmitter amplifier 8 when a signal is transmitted or isolates the transmitter amplifier 8 from the receiver amplifier 10 when a signal is received. The bandpass filter 18 filters the signal spectrum in order to suppress signals outside the frequency band of the system.

The complexity of this approach limits the minimum cost and occupied space as well as the performance due to the summation of all losses occasioned by each of the functions and mismatch losses at the interfaces between them.

It is an object of the invention to provide a method of processing signals in a transmitter and/or receiver module with less complexity, resulting in a lower cost.

To achieve this object, a method according to the invention of processing signals to be transmitted from a transmitter module comprising a dipole antenna and a transmitter power amplifier for amplifying the transmitted signal, and/or to be received from a receiver module comprising a dipole antenna and a receiver amplifier for amplifying the received signal, which method comprises a step of providing differential signals from the transmitter power amplifier to the antenna and/or from the antenna to the receiver amplifier without converting the differential signals to single-ended signals. It is a major advantage of the invention that the balun is eliminated. This results in a reduced size, a reduced cost and an improved performance of the transmitter and/or receiver module. Also, the transmitter and/or receiver module of the invention is suitable for implementation in hybrid modules. This is advantageous in that the cost of assembly can be reduced substantially and in that the several other functions can be integrated into the module of the invention. It is understood that said antennas of the receiver amplifier and the transmitter power amplifier may be the same.

To achieve the above object, a transmitter and/or receiver module comprising a dipole antenna, a transmitter power amplifier for amplifying the transmitted signal, and/or a receiver amplifier for amplifying the received signal is provided, wherein the antenna and the transmitter power amplifier and/or the receiver amplifier are connected through double line connections, respectively, whereby differential signals from the antenna are provided to the receiver amplifier and from the transmitter power amplifiers to the antenna without conversion of the differential signals to single-ended signals. Since the balun is eliminated, the transmitter and/or receiver module has a reduced size and lower cost.

According to a preferred embodiment of the transmitter and/or receiver module of the invention having a balanced switch circuit for switching between received and transmitted signals, the antenna and the transmitter power amplifier for amplifying the transmitted signal and/or receiver amplifier for amplifying the received signal are connected through double line connections to the switch circuit.

According to a preferred embodiment of the transmitter and/or receiver module of the invention, one and the same antenna is used for the transmitter module and/or the receiver module. This antenna is balanced with respect to the ground.

According to a preferred embodiment of the transmitter and/or receiver module of the invention having a matching circuit matching the impedance of the antenna and the transmitter power amplifier and/or the receiver amplifier, the antenna comprises two antenna sections which are connected to the matching circuit at two distinct nodes thereof.

According to a preferred embodiment of the transmitter and/or receiver module of the invention, the matching circuit and the antenna are designed to include the bandpass filter of the module. This reduces the complexity by integrating the bandpass filter function into the matching circuit design and the antenna design.

According to a preferred embodiment of the transmitter and/or receiver module of the invention, the antenna is a narrowband antenna.

According to a preferred embodiment of the transmitter and/or receiver module of the invention, the matching circuit is an integrated parallel resonant impedance matching circuit. The integration of the matching circuit, advantageously reduces the size of the transmitter and/or receiver module.

The use of a narrow-band antenna in combination with a matching network that is parallel resonant is a preferred way of eliminating the bandpass filter which had been required up to now.

According to a preferred embodiment of the transmitter and/or receiver module of the invention, the combination of the impedance matching circuit and a dipole radiator antenna form a two-pole band pass filter, which is balanced. This leads to a further size reduction and an improved out-of-band frequency selectivity.

According to a preferred embodiment of the transmitter and/or receiver module of the invention, the antenna comprises a stepped-impedance printed dipole. The impedance step results in an increased impedance bandwidth and a reduced capacitive reactance, resulting in a reduced antenna size.

According to a preferred embodiment of the transmitter and/or receiver module of the invention, the stepped-impedance printed dipole consists of two printed connection lines leading to two dipole bars, the difference in line width between the connection lines and the dipole bars forming the step of the stepped-impedance printed dipole. Such an antenna is small with respect to wavelength and symmetrical with respect to ground.

According to a preferred embodiment of the module of the invention the signal band is between 2,402 GHz and 2,480 GHz (Bluetooth® application). In general, the module is suitable for any cellular and short-range wireless TDMA—Time Domain Multiple Access—systems, thus systems in the 1-6 GHz range.

According to a preferred embodiment, the transmitter and/or receiver amplifier module of the invention is be a hybrid module. This reduces the size of the module. Hybrid technology is a combination of different technologies. In this case a silicon integrated circuit is used for the RF part and a laminated substrate and discrete surface-mounted-device (smd) components are used for the passive part of the module. This technology results in a low cost and small front end with improved performance which will be described in detail further below.

It is another object of the invention to provide a substrate with an antenna which allows building up a transmitter and/or receiver module with less complexity resulting in a lower-cost product.

To achieve the above object, a substrate is provided with a dipole antenna, the antenna comprising an impedance step arrangement. The impedance step arrangement leads to a more uniform current distribution resulting in more radiation.

According to a preferred embodiment of the substrate of the invention, the impedance step is realized in that the dipole antenna comprises two connecting parts each having a connection line and a dipole bar, which dipole bar has a greater width than the connection line. It is an advantage of this embodiment that a shorter antenna can be used at the frequency of interest thanks to the widening of the dipole bars. Furthermore, the dipole bars and the connection lines as well as other interconnects can be provided on the substrate by a suitable technology such as sputtering, printing, vapor deposition. Besides, the antenna, being built up from two parts, can be designed such that only a minimum of space on the substrate is used.

In a further embodiment, a parallel resonant impedance matching circuit is present where the parts of the antenna interconnect, a major portion of the matching circuit and the antenna being embodied in one electrically conductive layer. The electrically conductive layer preferably comprises a metal. It is an advantage of the embodiment that an additional bandpass filter is not necessary. The function of the bandpass filter is integrated in the antenna plus the matching circuit, said matching circuit comprising a first and a second line which are parallel to each other and mutually coupled by the connection lines on the one side and a capacitor on the other side, as is further indicated in the Figures and the description.

The substrate of the invention is a good basis for building up the above transmitter/receiver module because the substrate with the antenna formed thereon can be used to attach the other active and passive components of the above transmitter/receiver module. In other words, the switch circuit and the transceiver device, which may be integrated into one die, and the capacitor are placed on the substrate with the antenna having the impedance step. If desired, the capacitor of the matching circuit and additional capacitors and passive components may be integrated into a network of passive components. Alternatively, passive components and interconnect lines may be integrated in the substrate, this substrate being of the multilayer type with insulating layers between conductive foils. Although it is preferred to provide the antenna parts at the same side of the substrate as the active and/or passive components, these components may be provided on the reverse side. The substrate may further comprise a cavity in which any discrete components may be present. However, this is not the preferred embodiment, since this will increase the height of the module.

It is a further object of the invention to provide a consumer electronics device with a receiver/transmitter module that can be used as a plug-and-play module for any manufacturer or consumer who does not have any antenna knowledge. This object is realized in that the consumer electronics device comprises the receiver and/or transmitter module of the invention. As is well known, there is a trend towards a mobile communication over short distances. This trend envisages that various consumer electronics devices can be coupled and driven as one system. Examples of consumer electronics devices include personal computers, personal digital assistants (PALM), laptops, remote, controls, and mobile phones. The integration of the receiver and/or transmitter module of the invention into a consumer electronics device provides the means for making said communication over short distances possible. Besides, the integration of the module of the invention has the advantage that the interference or any other undesired coupling to other functional circuits in such consumer electronics device will be small in comparison with modules having monopole antennas. This is due to the use of the dipole antenna, which will not generate currents in the ground plane of the device, whereas the operation of monopole antennas depends on the generation of such currents. It is a further advantage of the integration of the module of the invention that all the necessary functions are integrated onto one substrate that can be placed on a printed circuit board or inserted into the device like a modem/SIM-card. Apart from the fact that this integration onto one substrate provides a module that can be handled easily, the module is very thin, and therefore fits into a large variety of portable devices that are thin or become increasingly thinner.

These and various other advantages and features of novelty which characterize the present invention are exactly defined in the claims annexed hereto and forming part hereof However, for a better understanding of the invention, its advantages, and the object obtained by its use, reference should be made to the drawings which form a further part hereof, and to the accompanying descriptive matter in which and described preferred embodiments of the present invention are illustrated.

Preferred embodiments of the invention will now be described with reference to the drawings, in which

FIG. 1 is a blockdiagram of a conventional transmitter and/or receiver module;

FIG. 2 is a blockdiagram of a transmitter and/or receiver module in an embodiment of the invention;

FIG. 3 is a plan view of a transmitter and/or receiver module in an embodiment of the invention;

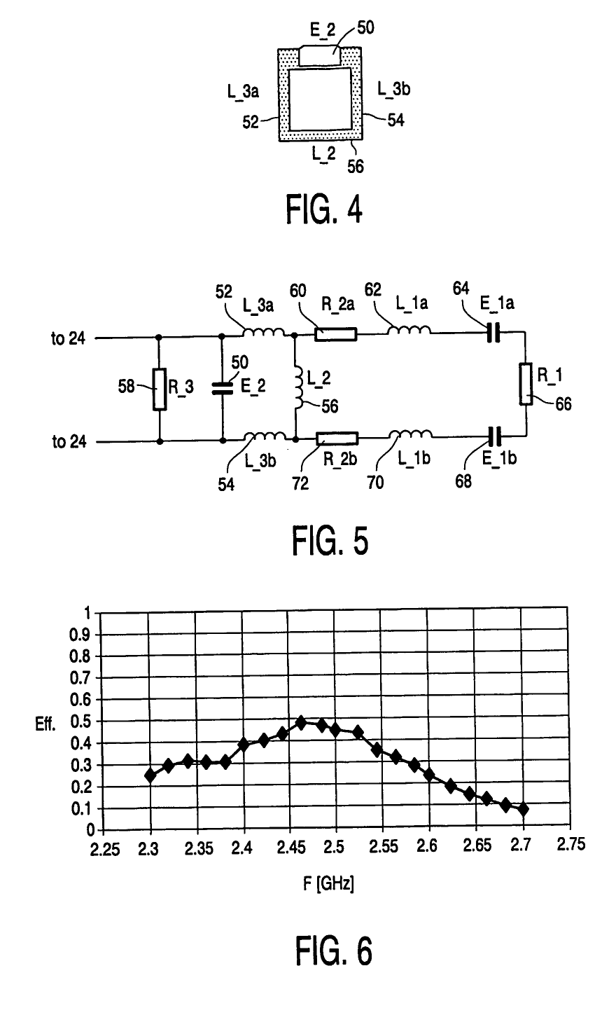

FIG. 4 is a detailed view of an impedance matching circuit of the transmitter and/or receiver module in an embodiment of the invention;

FIG. 5 is an equivalent circuit diagram of the combination of the impedance matching circuit and the dipole radiator antenna;

FIG. 6 is a diagram of the measured radiation efficiency of the antenna plus matching network;

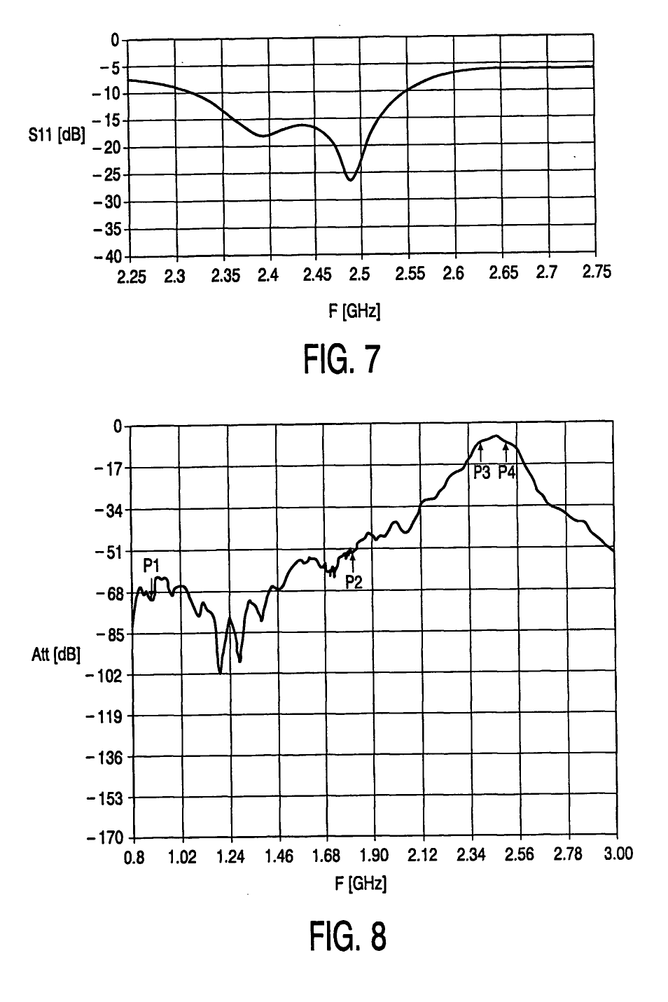

FIG. 7 is a diagram of the measured input reflective coefficient S11; and

FIG. 8 is a diagram of the wide-band transfer characteristic.

FIG. 2 is a blockdiagram of an embodiment of the transmitter and/or receiver module of the invention. The module comprises a front end transmitter/receiver circuit 22, a switch 24, and a dipole antenna 28 (ANT) connected to a matching circuit 26. The transmitter/receiver circuit 22 comprises a transmitter power amplifier 30 (PA) for the transmitter function and a receiver low-noise amplifier 32 (LNA) for the receiver function.

The switch 24 is in cascade between the transmitter/receiver circuit 22 and the matching circuit 26 of the antenna 28.

The matching circuit 26 and the switch 24 are connected through a double line connection 25. The switch 24 and the transmitter power amplifier 30 are connected through a double line connection 27, and the switch and the receiver amplifier 32 are connected through double line connection 29. Differential signals to the antenna 28 are thus provided by the transmitter power amplifier 30 and from the antenna (28) to the receiver amplifier 32 without conversion of the differential signals to single-ended signals. Therefore, the balun which was necessary in the conventional circuit is eliminated.

FIG. 3 shows an example of an implementation of the transmitter and/or receiver module of the embodiment of FIG. 2 in a Bluetooth® transceiver module. The power amplifier 30, the low-noise amplifier 32, the transmit/receive switch 24, the antenna matching circuit 26, and the antenna 28 are formed on a laminated circuit board 34. A ground plane (not shown) is formed in particular printed on the back of the circuit board 24.

The antenna 28 is a dipole antenna and comprises two printed connection lines 36,38 leading from the matching circuit 26 to two dipole bars 40, 42, respectively. The dipole bars 40,42 are connected via the connection lines 36,38 to two distinct nodes 41,43 of the matching circuit. The dipole bars 40,42 together exhibit a characteristic impedance. These impedance values of the connecting lines and the dipole bars depend upon the line width of the connection lines 36, 38 and the dipole bars 40, 42. In this embodiment, dipole lines with a step in line width are used which corresponds to a step in the characteristic impedance.

In a dipole with uniform impedance (no impedance step), the current decreases from a maximum in the middle to zero at the ends of the antenna. Only those parts of the antenna 28 that carry RF current contribute to the radiation. The impedance step results in a more uniform current distribution, resulting in more radiation, given a certain current at the feed point. This improves the impedance bandwidth of the antenna 28. Furthermore, the wide-line (low-impedance) sections of the antenna, i.e. the dipole bars 40,42, lower the resonance frequency for a given antenna size. This means that a shorter antenna can be used at the frequency of interest.

The power amplifier 30 is only capable of delivering the desired RF power to the antenna 28 if the input impedance of the antenna 28 equals the value for which the amplifier 30 was designed. Likewise, the antenna 28 is only capable of delivering all received power to the low-noise amplifier 32 if the input impedance of the low noise amplifier 32 is equal to the output impedance of the antenna 28. In practice the impedance levels do not have to be equal but should be matched to a certain degree. The matching circuit 26 improves this match over the passband of the system.

The transmitter and/or receiver module of the above embodiment is selective as to frequency, which means that it discriminates with respect to frequency. This offers the possibility to attenuate undesired signals outside the frequency band for which the system is designed, and to pass the signals in the desired frequency band, the so called passband.

FIG. 4 is a detailed view of the impedance matching circuit 26 having the above functions. It comprises, in terms of an equivalent circuit, a shunt capacitance 50 (C_2) which is a smd component in parallel to an input of the impedance matching circuit 26. The shunt capacitance 50 is connected on either side to a respective series inductance 52, 54 (L_3a, L_3b), the other sides of the series inductances 52, 54 being interconnected through a shunt inductance 56 (L_2) which in its turn is connected in parallel to an output of the impedance matching circuit 26. The values of the inductances 52, 54, and 56 depend on the width and length of the printed line. The values of the inductances 52, 54, and 56 and the value of the capacitance 50 are determined by the frequency band of the passband.

The shunt capacitance 50, the series inductances 52, 54, and the shunt inductance 56 form a parallel resonant circuit which is a parallel combination of a capacitor and an inductor. In this case the inductor is split up into three parts so as to offer the appropriate impedance level to the antenna. The two distinct nodes 41,43 of the matching circuit 26 are located at the two ends of the shunt inductance 56.

FIG. 5 is an equivalent circuit diagram of the combination of the impedance matching circuit and the dipole radiator antenna. The output of the impedance matching circuit is connected to the dipole radiator antenna 28 which comprises, in equivalent circuit terms, a series circuit of a first loss resistance 60 (R_2a), a first inductance 62 (L_1a), a first capacitance 64 (C_1a), a radiation resistance 66 (R_1), a second capacitance 68 (C_1b), a second inductance 70 (L_1b), and a second loss resistor 72 (R_2b).

The first inductance 62, the first capacitance 64, the radiation resistance 66, the second capacitance 68, the second inductance 70, and a second resistor 72 form a series resonant circuit. The circuit is split in two due to the balanced nature of the antenna.

The circuit comprises two resonators, a parallel resonator, and a series resonator. The parallel resonator comprises the shunt capacitance 50, the series inductances 52, 54, and the shunt inductance 56. The series resonator comprises the first inductance 62, the second inductance 70, the first capacitance 64, and the second capacitance 68.

The circuit topology of the module shows that the combination of the dipole antenna plus the matching circuit is equivalent to a classical two-pole bandpass filter. In other words, the function of the bandpass filter is combined or integrated in the matching circuit 26 and the antenna 28, resulting in one small building block with reduced complexity.

In embodiment of the integrated parallel resonant impedance matching circuit, the parallel resonance is the result of the two lines 52,54 shunted by the capacitor 50.

The integration of the module refers also to the integration of the antenna circuit 28, the matching circuit 26, the switch circuit 24, and the transceiver 30,32 on the same (laminate) substrate 34.

FIG. 6 is a diagram of the measured radiation efficiency of the antenna plus matching network of the transmitter and/or receiver module of the above embodiment of the invention for the Bluetooth® application, and FIG. 7 is a diagram of the measured input reflective coefficient S11 for the transmitter and/or receiver module of the above embodiment of the invention for the Bluetooth® application.

The radiation efficiency is a ratio of the radiated power to the power actually entering the antenna terminal. The reflective coefficient S11 is a measure for the quality of the input impedance match of a device to its nominal value. The reflective coefficient S11 is defined as the ratio of the reflected wave to the incoming wave at port 1 of a two-port network if port 2 is terminated without reflection. A so-called return loss value of −10 dB corresponds to a voltage to standing wave ratio (VSWR)<2:1. This means that the impedance deviates by no more than a factor two from its nominal value (typically 50 ohms). The VSWR ratio of 2:1 is a typical value for antennas in mobile phones, and the associated mismatch loss (0.5 dB) is just acceptable for this mismatch level.

FIG. 6 relates to the embodiment having the stepped impedance printed dipole antenna and shows a comparison with a classical dipole, being the antenna without impedance step with a uniform cross-section along its length. The efficiency diagram of FIG. 6 is not only of relevance for the radiation efficiency of the antenna, but also for the module as a whole. Since the matching circuit and the antenna are the most critical parts with respect to loss, the efficiency proves that the signal transfer between the transmitter/receiver and the antenna will be adequate, although there is no balun.

FIGS. 6 and 7 also show that a more than 40% radiation efficiency in combination with a return loss level better than −10 dB is achieved over a bandwidth of 4%. This is a significant improvement over a classical printed dipole with the same size, which offers only 1% impedance bandwidth at a return loss level of −10 dB.

The impedance bandwidth is the frequency span (bandwidth) over which the impedance deviation of the antenna from the nominal value is less than a certain value. The nominal value is typically 50 ohms. The bandwidth is often specified for an VSWR value of 2:1, which means that the actual antenna impedance deviates by no more than a factor 2.

Additionally, FIG. 7 shows that a better than 10 dB return loss is achieved between roughly 2350 MHz and 2550 MHz, so over a span of 200 MHz centered around the Bluetooth® center frequency of 2450 MHz. The advantage of the large impedance bandwidth is that the antenna will not be disturbed easily by its environment. Small frequency shifts of the antenna due to variations in the environment will not lead to a serious impedance mismatch and a corresponding signal loss.

FIG. 8 is a diagram of the wide-band transfer characteristic for Bluetooth®, and it shows in particular the selectivity of the bandpass filter in the stepped impedance printed dipole of the invention. It can be seen that the antenna additionally offers a considerable attenuation of out-of-band signals. The minimum of the attenuation lies in the frequency band of Bluetooth®. The attenuations for the frequencies of 2.4 GHz and 2.5 GHz are equal to approximately −3.4 dB and −3.3 dB at P3 and P4. The attenuation for a frequency of 900 MHz is equal to −35 dBc and the attenuation for a frequency of 1800 MHz is equal to −25 dBc. The unit dBc denotes a signal level relative to the carrier. The carrier in this case is the signal level in the passband.

The curves shown in FIGS. 6, 7 and 8 are characteristic of a transmitter and/or receiver module in the Bluetooth® application. Comparable results are obtained for GSM applications in the characteristic frequency bands of between 1710 MHz and 1880 MHz (GSM 1800) and between 1850 MHz and 1990 MHz (GSM 1900), for example. The diagrams would differ only in that other frequencies are applicable to the signal band. Obviously, the size of the dipole bars of the antenna would also be different.

New characteristics and advantages of the invention covered by this document have been set forth in the foregoing description. It will be understood, however, that this disclosure is, in many respects, only illustrative. Changes may be made in details, particularly in matters of shape, size, and arrangement of parts, without departing from the scope of the invention. The scope of the invention is, of course, defined in the terms in which the appended claims are expressed.

1. A method of processing signals
to be transmitted from a transmitter module comprising a dipole antenna and a transmitter power amplifier for amplifying the transmitted signal; and/or
to be received from a receiver module comprising a dipole antenna and a receiver amplifier for amplifying the received signal, which method comprises a step of providing differential signals from the transmitter power amplifier to the antenna and/or from the antenna to the receiver amplifier without conversion of the differential signals to single-ended-signals.

2. A method as claimed in claim 1, wherein one and the same balanced antenna is used for the transmitter module and/or the receiver module.

3. A transmitter and/or receiver module comprising
a dipole antenna (28),
a transmitter power amplifier (30) for amplifying the transmitted signal, and/or
a receiver amplifier (32) for amplifying the received signal, wherein
the antenna (28) and the transmitter power amplifier (30) and/or the receiver amplifier (32) are interconnected respective through double line connections (25,27;25,29), whereby
differential signals from the antenna are provided to the receiver amplifier (32) and from the transmitter power amplifier (30) to the antenna (28) without conversion of the differential signals to single-ended signals.

4. A module as claimed in claim 3 having a balanced switch circuit (24) for switching between received and transmitted signals, wherein the antenna (28) and the transmitter power amplifier (30) for amplifying the transmitted signal and/or the receiver amplifier (32) for amplifying the received signal are connected through double line interconnections (25,27,29) to the switch circuit (24).

5. A module as claimed in claim 3 having a matching circuit (26) matching the output impedance of the antenna (28) and the transmitter power amplifier (30) and/or the receiver amplifier (32), wherein the antenna (28) comprises two antenna sections (40,42) which are connected to the matching circuit (26) at two distinct nodes (41,43) thereof.

6. A module as claimed in claim 5, wherein the matching circuit (26) and the antenna (28) are designed to provide a bandpass filter function for the module.

7. A module as claimed in claim 3, wherein the matching circuit (26) is an integrated parallel resonant impedance matching circuit.

8. A module as claimed in claim 3, wherein the combination of the impedance matching circuit (26) and a dipole radiator antenna (28) forms a two-pole band-pass-filter.

9. A module as claimed in claim 3, wherein the antenna (28) comprises a stepped-impedance printed dipole.

10. A substrate provided with a dipole antenna, said antenna comprising an impedance step arrangement.

11. A substrate as claimed in claim 10, wherein the impedance step is realized in that the dipole antenna comprises two connecting parts each having a connection line and a dipole bar, which dipole bar has a larger width than the connection line.

12. A substrate as claimed in claim 11, characterized in that a matching circuit is present where the parts of the antenna interconnect, a major portion of said matching circuit and the antenna being embodied in one electrically conductive layer.

13. A consumer electronics device comprising the module as claimed in claim 1.
